(19) United States
(12) Patent Application Publication
(10) Pub. No.: US 2010/0163635 A1
(43) Pub. Date: Jul. 1, 2010

(54) THERMOSTAT WITH GFCI

(75) Inventor: Leo YE, Shanghai (CN)

Correspondence Address: BIRCH STEWART KOLASCH & BIRCH, PO BOX 747, FALLS CHURCH, VA, 22040-0747, US

(73) Assignee: Shanghai OkOnOff Electric Co., Ltd., Shanghai (CN)

(21) Appl. No.: 12/644,636

(22) Filed: Dec. 22, 2009

(30) Foreign Application Priority Data
Dec. 25, 2008 (CN) 200820157788.7

(51) Int. Cl. F24F 11/00; G05D 23/19; F24H 9/20

(52) U.S. Cl. 236/94; 236/91 F; 165/253

(57) ABSTRACT

The present invention provides a thermostat with GFCI which includes control module, keyboard module, communication module and display module, and it further includes a leakage detection module, and the control module includes the temperature sensor, and the leakage detection module is connected with the control module, keyboard module and display module respectively. The control module is connected with the controlled device by the leakage detection module. The thermostat monitors current status of output circuit while adjusting the temperature of room, so that it can ensure the safety of the output circuit in use. If leakage occurs to the controlled device, the thermostat can cut off the power and stop power supplying at once, and the alarm light illuminates in the meantime. After manual reset, the alarm light goes out. It works with a wide input voltage range and makes the thermostat normally work at multistage voltage, and it can detect the leakage current accurately, and cut off power in time and report to the system.

### FIELD OF INVENTION

The present invention relates to a thermostat, particularly relates to a thermostat with GFCI (Ground-Fault Circuit Interrupter), which uses the electric load as the controlled object.

### BACKGROUND OF THE INVENTION

With the improved requirement of comfortable life, various modernize HVAC equipments have become more popular in the habitable environment, such as floor heating, cable heating, electro-thermal film heating, electric radiation panel, electric heater and so on. At the same time, it has generally applied in industry and agriculture. Therefore, it needs the advanced device or equipment to control temperature. Thermostat is the most ordinary device for controlling temperature at present.

Thermostat belongs to the temperature controlling device, and it can control cold and heat sources device according to the contrast between the required temperature and current temperature. It can achieve the user's required temperature by increasing or decreasing temperature, so that it meets the purpose of comfort and energy-saving.

In theory, there are many ways to realize above purpose. In fact, there are two series at present, mechanical thermostat and electronic-type intelligent thermostat.

The early stage of thermostat is the mechanical thermostat which adopts the bi-metallic strip or the gas filled bellow to sense room temperature and realize control cold and heat source, and it can achieve the user's required temperature by increasing or decreasing temperature, Nowadays, the bimetallic strip thermostat has already been eliminated, it is only used in some occasions which is not higher requirement or in lower level occasion. Generally speaking, the function of mechanical-type thermostat is simple and it has big deviation for measuring temperature.

The electronic-type intelligent thermostat belongs to the highly advanced product, and especially it is widely used in the fields of industry and agriculture, scientific research and daily life, so the number of thermostats is increasing. In recent 100 years, the development of thermostat has undergone the following stages:
(1) Analog integrated mechanical-type thermostat;
(2) Electronic intelligent thermostat;
(3) Intelligentized and networking thermostat.

However, the thermostat of the market is mainly applied to control the room temperature at present, but the controlled device works in the condition of commercial AC 220 v. Electric leakage is an important problem we should take into account, because it can cause danger and threat for the security of people, animals, as well as some devices. Recently, most of the thermostats of the market have no function of GFCI (Ground-Fault Circuit Interrupter), so they virtually have hidden troubles for the security of people and equipments.

### SUMMARY OF INVENTION

In order to solve the problems that the thermostat cannot differentiate whether it is leakage or not and it does not detect the current of the load circuit, the present invention solves said technologic problems and puts forward a new proposal. That is this thermostat can not only control temperature and equipment, but also it can detect the current of load circuit. It has the function of GFCI (Ground-Fault Circuit Interrupter), and can detect the current of load return circuit and its supply circuit. According to the requirements of the standard, it can rapidly detect and handle the corresponding detecting result, and ensure the security of users.

A thermostat with GFCI for maintaining the temperature to a default value and includes control module, keyboard module and display module, which is characterized in that it further includes a leakage detection module, and the control module includes the temperature sensor, which is used to collect the external temperature, and the leakage detection module is connected with the control module, keyboard module and display module respectively, and the control module is connected with the controlled device by the leakage detection module.

Said leakage detection module includes a leakage fault protection chip, a detection circuit, an output circuit and a signal reset circuit.

Said output circuit includes two optical couplers which are used for separating input signal and output signal.

Said detection circuit includes a circuit which is used for deciding whether leakage exists in the circuit or not by detecting whether the current of L line and N line of the current transformer is equal. Said current transformer is located near AC power source to detect whether leakage exists or not in the controlled device and the thermostat simultaneously.

Said leakage detection module includes the indicator which is used for indicating circuit leakage. And it includes LED.

Preferably, the display module includes display symbol which is used for indicating circuit leakage. The control module is connected with and control the controlled device by relay.

Compared to the existing technology, the thermostat with GFCI in accordance with the present invention has the following advantages:
(1) The present invention use Ampere's law to detect the induction current produced in the current transformer caused by the unequal between the current in the L line and N line, and then delivers leakage signal to the control module after the processing by said leakage detection module. And the control module can delivers disconnection signal, so that it can protect human safety and property effectively.
(2) Structurally, the space-embedded type method is adopted to make the components compact and tidy. The thermostat can be smaller, nice and occupying less space;
(3) The display module adopts character-type LCD, and the operation of it is simple and convenient;
(4) The housing of the thermostat is made of engineering plastic, which has high temperature resistance and high strength;
(5) The thermostat has the function of communication, so it can report its status in time. The thermostat with GFCI (Ground-Fault Circuit Interrupter), in accordance with the present invention, monitors current status of output circuit while adjusting the temperature of room, so that it can ensure the safety of the output circuit in use. If leakage occurs to the controlled device, the thermostat can cut off the power and stop power supplying at once, and the alarm light illuminates in the meantime. After manual reset, the alarm light goes out. It works with a wide input voltage range and makes the thermostat normally work at multistage voltage, and it can detect the leakage current accurately, cut off power in time and report to the system.

### BRIEF DESCRIPTION OF THE DRAWINGS

FIG. 1 is a schematic circuit diagram of the present invention.

FIGS. 2-1 and 2-2 describe a schematic circuit diagram of the leakage detection module of the present invention.

FIG. 3 is a schematic circuit diagram of the keyboard module of the present invention.

FIGS. 4-1 and 4-2 describe a schematic circuit diagram of the display module of the present invention.

FIGS. 5-1, 5-2, 5-3 and 5-4 describe a schematic circuit diagram of the control module of the present invention (including communication part).

### DETAILED DESCRIPTION

In order to make the technological means, creative feature, purpose and functions of the present invention clear, we will give in-depth illustration associated with the following figures.

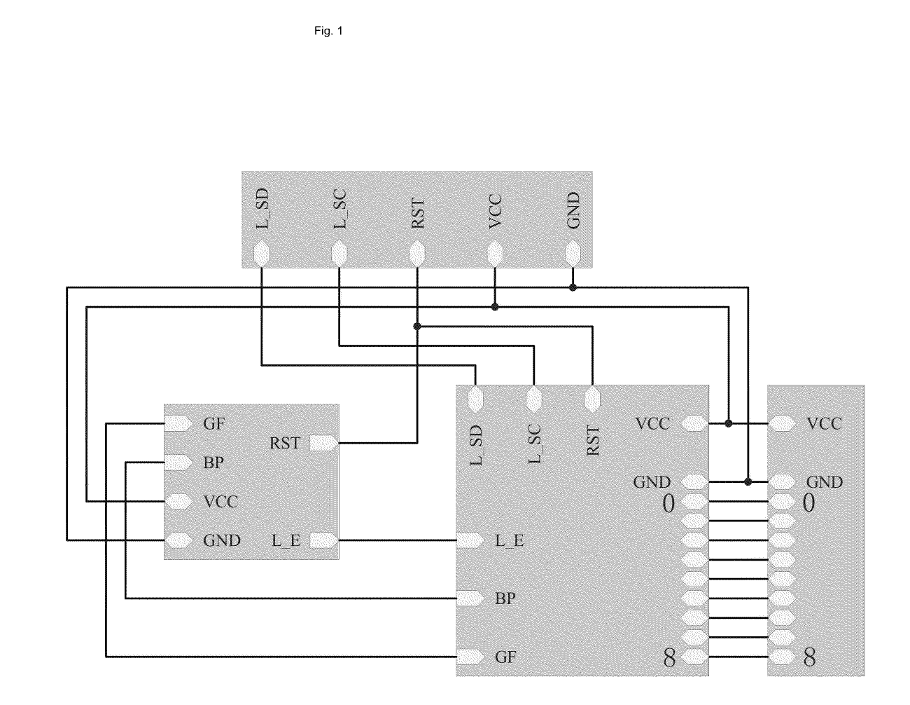

As shown in FIG. 1, a thermostat with GFCI includes control module 1, keyboard module 2 and display module 3, as well as a leakage detection module 4, and control module 1 is connected with keyboard module 2, display module 3 and leakage detection module 4 respectively, and leakage detection module 4 is connected with keyboard module 2 and display module 3 respectively, and control modules 1 is connected with the controlled equipment by leakage detection module 4, and the required working power of the controlled device must be detected by leakage detection module 4, and the working power of control module 1, keyboard module 2 and display module 3 must be detected by leakage detection module 4.

Temperature sensor is set in the control module 1 to collect the external temperature signal, and then to deliver the signal to the control module 1. The thermostat set temperature by control module 1 with keyboard module 2 according to actual needs. Control module 1 compares the temperature between external temperature, which is sensed by temperature sensor, and the temperature set by keyboard module 2 to deliver control signal and control the working status of the controlled device. In this embodiment, control module 1 is connected with and control the controlled device by the relay, and it can also use other means to control the controlled device, with out affecting achieving the purpose of the present invention. The controlled device can be the heating and air-conditioning equipment, such as heating cable, electro-thermal film and electric warmer, and it can provide working voltage with leakage detection module 4.

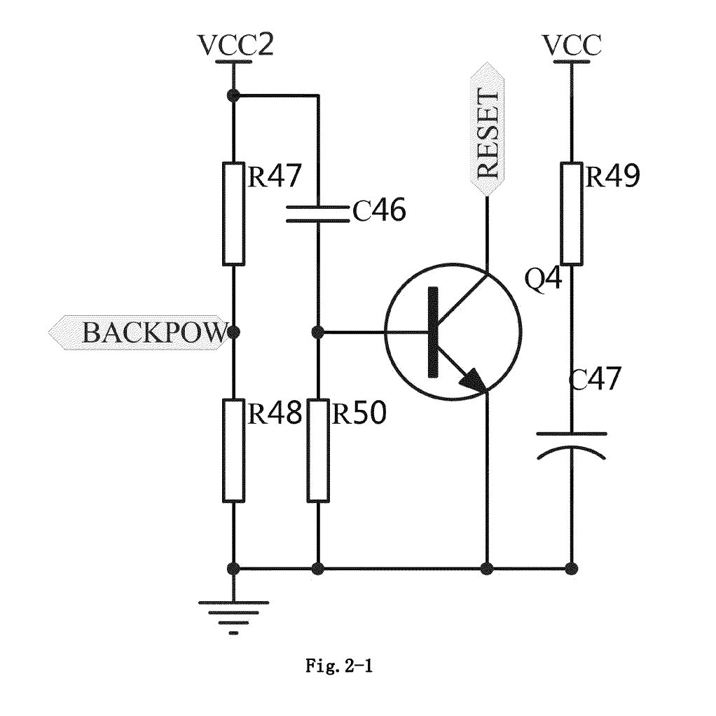

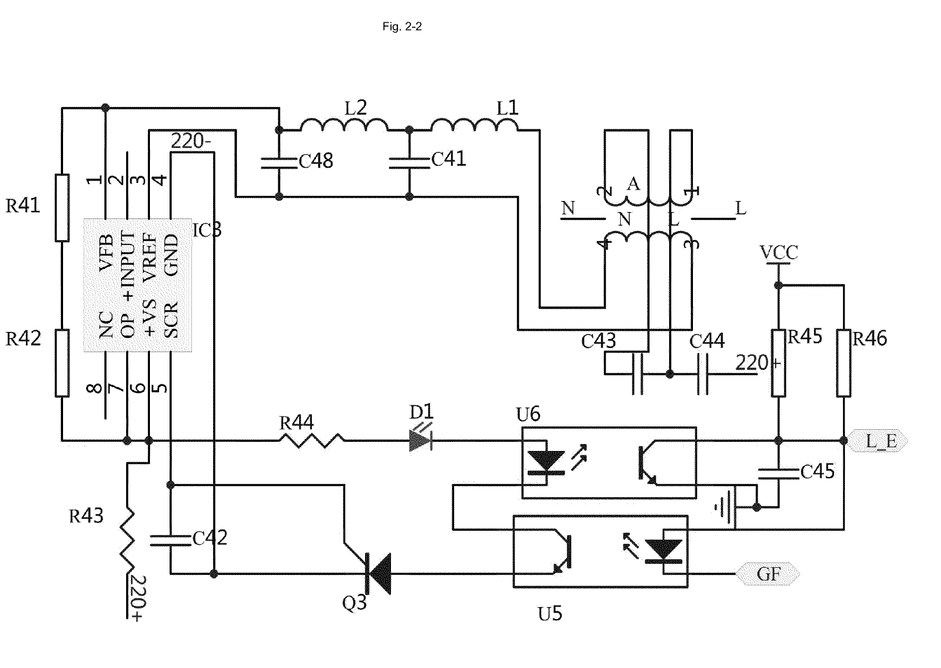

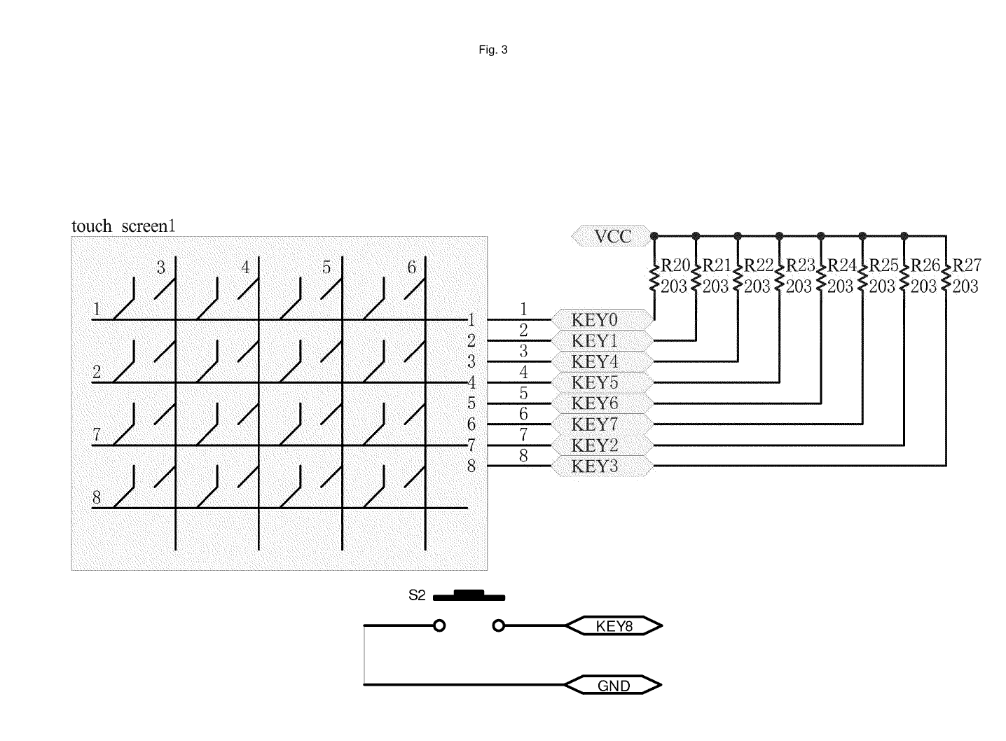

As shown in FIGS. 2-1 and 2-2, leakage detection module 4 includes a leakage fault protection chip IC3, a detection circuit 41 including current transformers, an output circuit 42 and a signal reset circuit 43.

Detection circuit 41 includes current transformer A, capacitor C41, C43, C44, C48 and inductor L1, L2; and PIN2 of current transformer A is connected with PIN1 of current transformer A by capacitor C43, and then it is connected with 220V+power by capacitor C44, and PIN3 and PIN4 are connected to PIN3 and PIN1 of leakage protection fault chip IC3, respectively, with the resonance circuit composed of inductor L1, L2 and capacitor C41 and C48, and PIN1 of leakage protection fault chip IC3 is connected with PIN7 of leakage protection fault chip IC3 by resistor R41 and R42, and PIN6 of leakage protection fault chip IC3 is connected with 220V+power by resistor R43, and the PIN4 of leakage protection fault chip IC3 is connected with PIN5 of leakage protection fault chip IC3 by capacitor C42.

Output circuit 42 includes optical coupler U5, U6, LED D1, resistor R44, R45, R46, controlled silicon Q3, capacitor C45. The PIN6 of leakage protection fault chip IC3 is connected with PIN1 of Optical coupler U6 by resistor R44 and LED D1. The PIN5 of leakage protection fault chip IC3 is connected with control terminal of controlled silicon Q3. The PIN5 of leakage protection fault chip IC3 is connected with cathode of controlled silicon Q3 by capacitor C42. The anode of Q3 is connected with PIN4 of optical coupler U5. The PIN2 of optical coupler U6 is connected with PIN3 of optical coupler U5. The PIN1 of optical coupler U5 inputs high level signal GFCI_STANDBY. The PIN1 of optical couplers U5 are respectively connected with resistance R45, R46, capacitor C45 and PIN3 of optical coupler U6. The PIN4 of optical coupler U6 is connected with the other end of capacitor C45 and grounded. The other end of resistor R45, R46 are connected with each other and with power supply VCC. The PIN3 of optical coupler U6 outputs low level leakage signal LOSS_E.

The signal reset circuit 43 includes transistor Q4, resistor R47, R48, R49, R50, and capacitor C46, C47. The resistor R47, R48 are connected with each other and input a BACKPOW signal on the joint of resistor R47 and R48. The other end of resistor R47 is connected with capacitor C46 and power supply VCC2. The other end of resistor R48 is connected with resistance R50, the emitter of transistor Q4 and capacitor C47, and grounded. The other ends of capacitor C46 and resistor R50 are together connected with the base of transistor Q4. The collector of transistor Q4 outputs a RESET signal. The other end of capacitor C47 is connected with power supply VCC by resistor R49.

One skilled in the art will comprehend, that the optical coupler U5 and U6 are used for separating input signal and output signal, so that output signal has no influence on input terminal, and it gets high anti-interference ability, and it makes the circuit working steadily. Similarly, one skilled in the art will also comprehend, that current transformer A is located near AC power source, so it can detect whether the controlled device or the thermostat in accordance with the present invention has leakage or not, to get better leakage detection results.

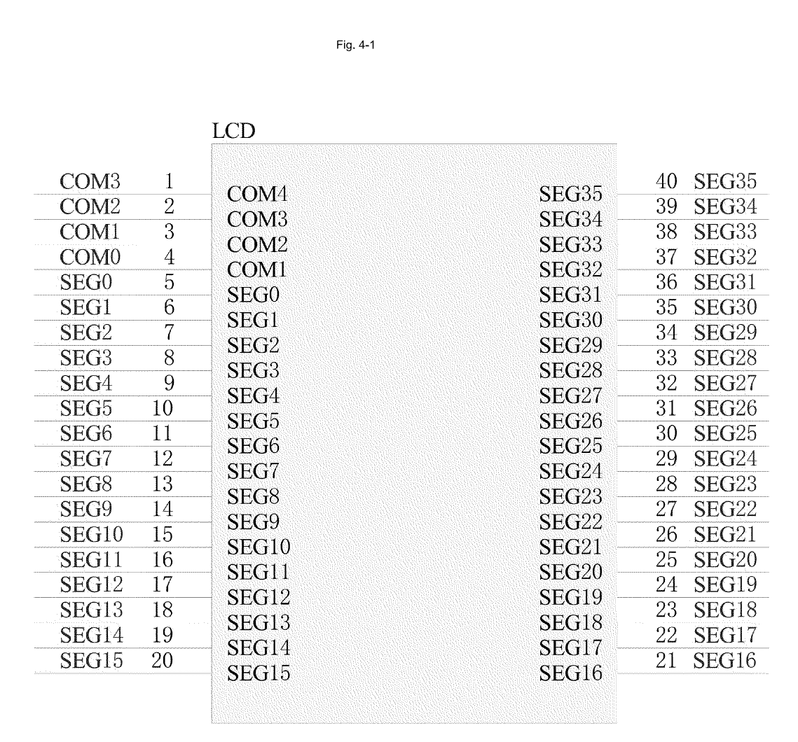

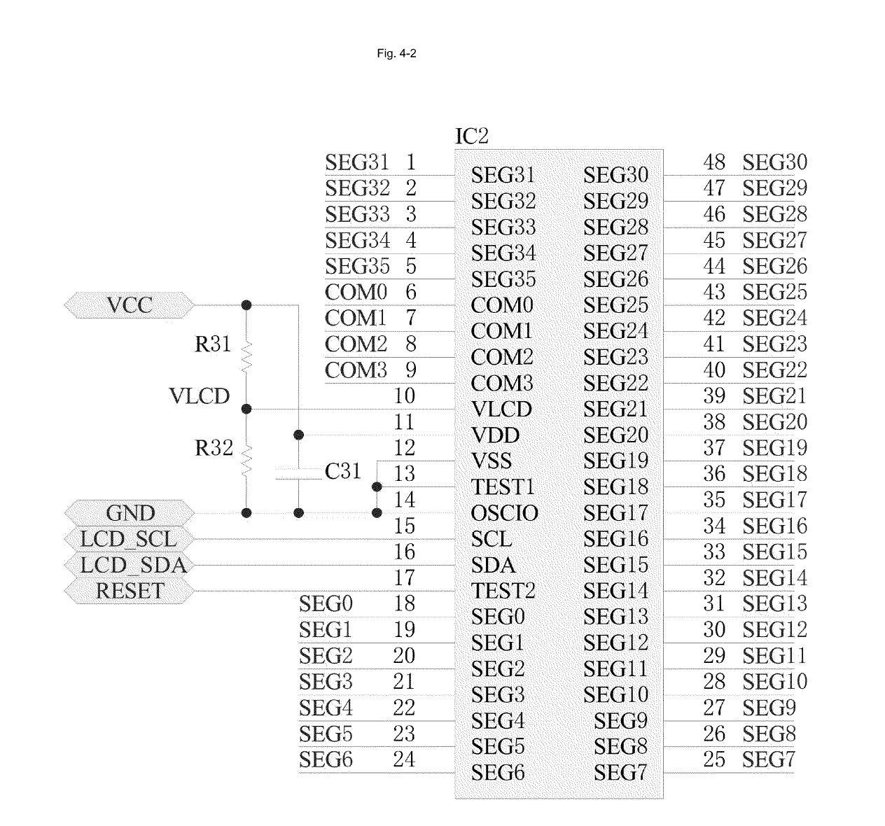

As shown in FIG. 3, the keyboard module 2 includes touch screen 1, resistor R20-R27 and button switch S2. PIN1-8 of touch screen are respectively connected with R20-R27 by signal KEY0-KEY7. The other ends of R20-R27 are connected with each other and with signal VCC. One end of button S2 is connected with signal KEY8; and the other end of button S2 is connected with signal GND.

As shown in FIGS. 4-1 and 4-2, the display module 3 includes control chip IC2, display board LCD and auxiliary circuit. PIN1-9, PIN18-48 of control chip IC2 are connected with PIN1-40 of display board LCD by bus. PIN10 of control chip IC2 is connected with signal VCC by resistor R31. The other end of resistor R31 is connected with PIN14 of control chip IC2 and with signal GND by resistor R32. The PIN11 of control chip IC2 is connected with PIN14 of control chip and with signal VCC by capacitor C31. PIN12 and PIN13 of control chip are connected with each other and with PIN14 of control chip IC2. PIN15 of control chip IC2 is connected with LCD_SCL. PIN16 of control chip IC2 is connected with signal LCD_SDA. PIN17 of control chip IC2 is connected with signal RESET.

As shown in FIGS. 4-1 and 4-2, one skilled in the art will comprehend, that the indicator for the circuit leakage is set in the display module. Specifically, when leakage occurs, the display module would show the indicating sign, symbol or feature code indicating leakage, accordingly.

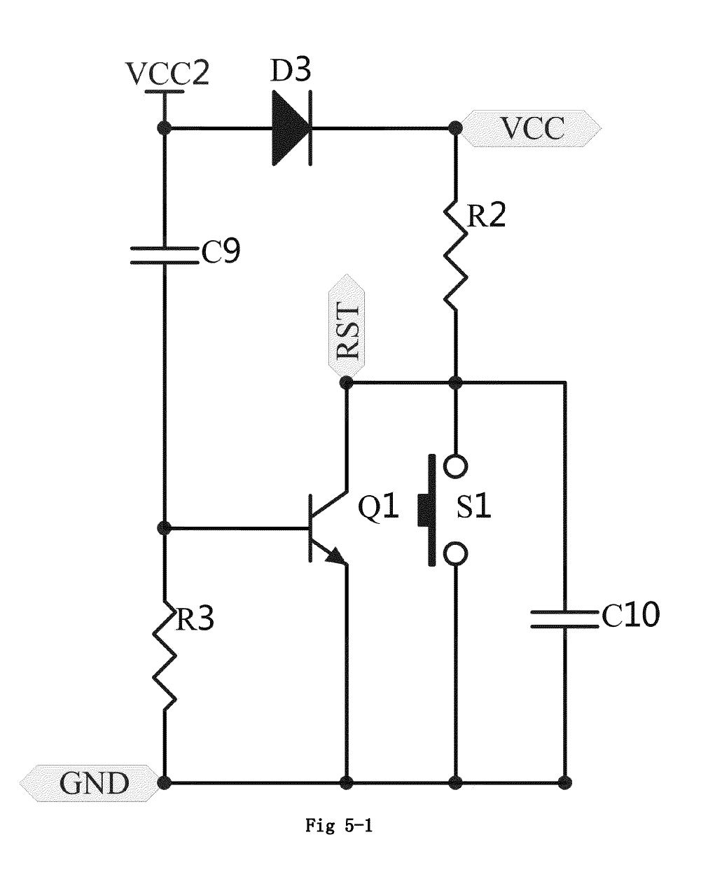

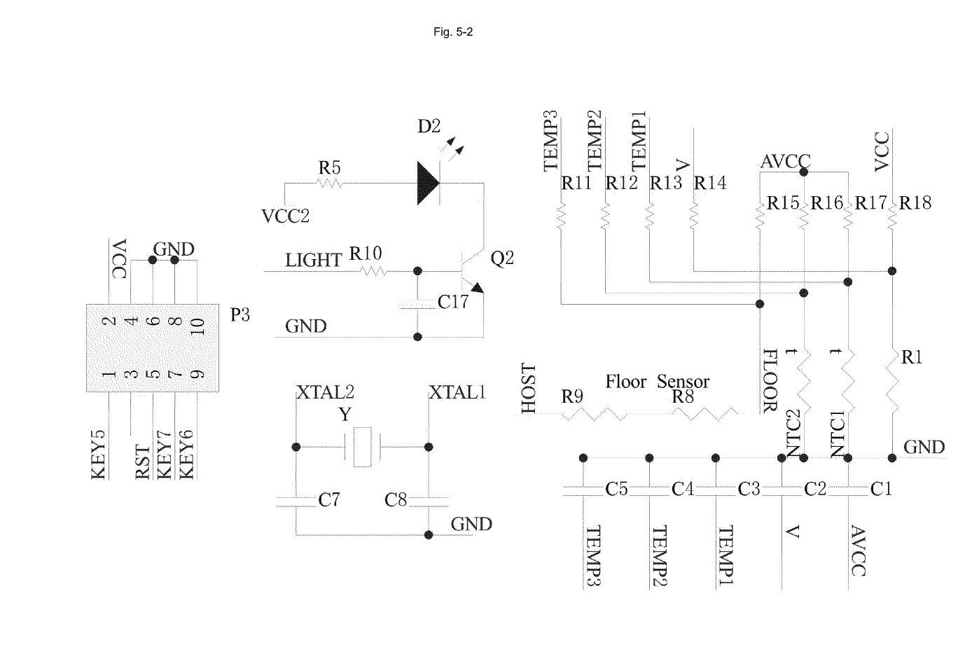

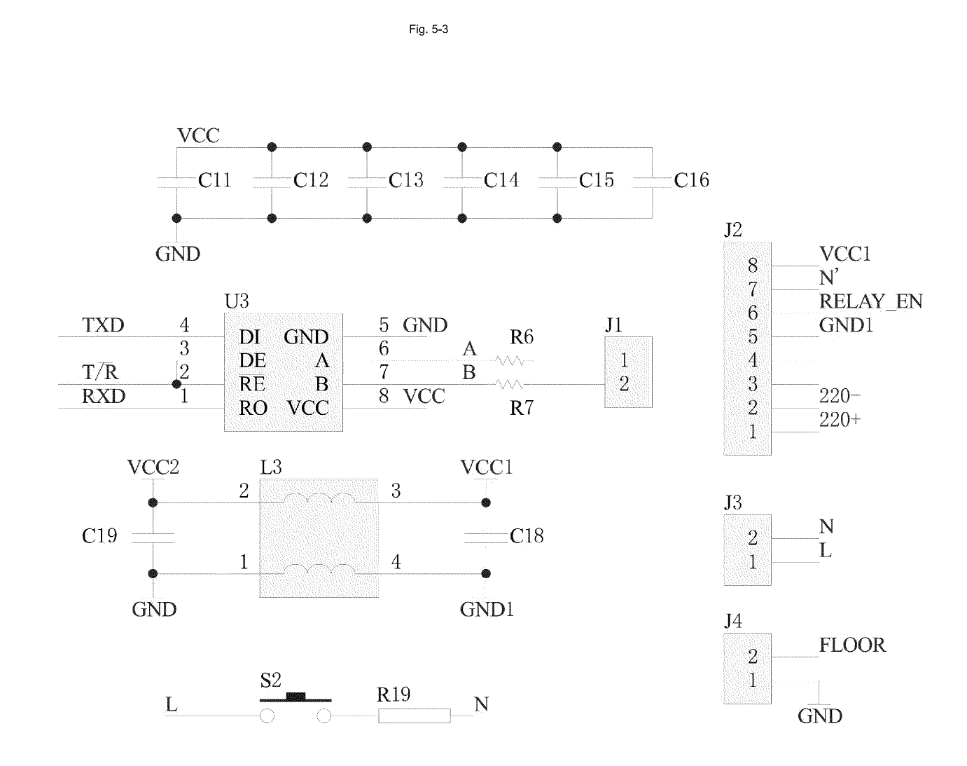

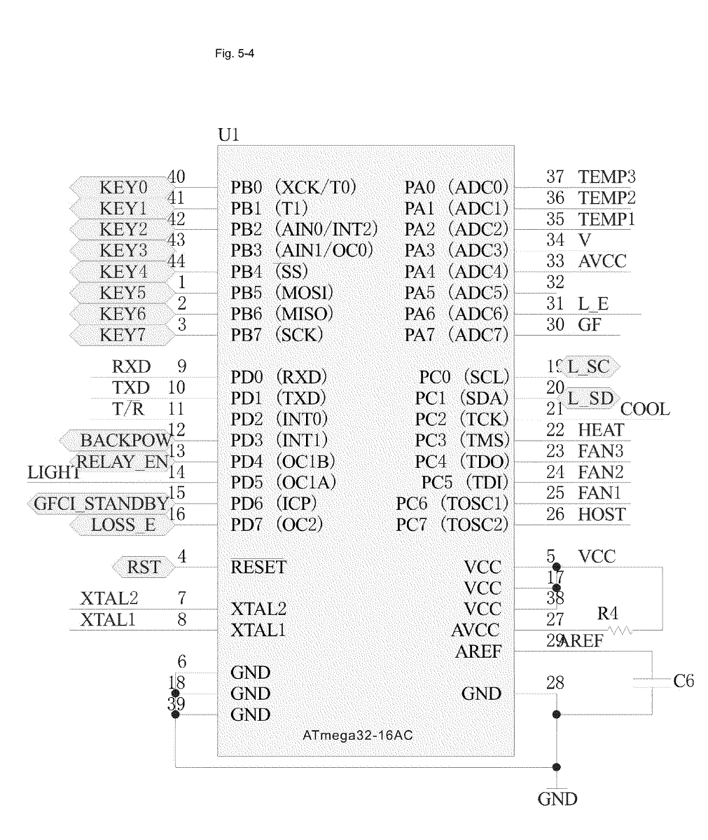

As shown in FIGS. 5-1, 5-2, 5-3 and 5-4, the control module 1 includes control chip U1, ISP interface module P3, communication module U3 and the auxiliary circuit. PIN29-37 of control chip U1 is orderly connected with capacitor C1-C6 and resistor R11-R17 by bus. The other end of capacitor C1-C6 is connected with each other and grounded GND. The other end of resistor R11 is connected with the other end of resistor R15 and with FLOOR, and with HOST by resistor R8, R9. The other end of resistor R12 is connected with the other end of resistor R116 and resistor NTC2. The other end of resistor R13 is connected with other end of resistor R17 and NTC1. The other end of resistor R14 is connected with resistor R18 and resistor R1. The other end of resistor NTC2, NTC1 and R1 are connected with each other and grounded GND. The other end of resistor R18 is connected with power supply VCC.

PIN5, 17, 38 of control chip U1 are connected with each other and connected to power supply VCC. PIN27 of control chip U1 is connected with the PIN5 of control chip U1 and connected to power supply VCC by resistor R4. PIN28 of control chip U1 is grounded. PIN6, 18, 39 of control chip are connected with each other and connected to the PIN5 of communication module U3. Signal KEY0 is connected with PIN40 of control chip U1. Signal KEY1 is connected with PIN41 of control chip U1. Signal KEY2 is connected with PIN42 of control chip U1. Signal KEY3 is connected with PIN43 of control chip U1. Signal KEY4 is connected with PIN44 of control chip U1. Signal BACKPOW is connected with the PIN12 of control chip U1. Signal RELAY_EN is connected with the PIN13 of control chip U1. Signal GFCI_STANDBY is connected with the PIN15 of control chip U1. Signal LOSS_E is connected with the PIN16 of control chip U1. Signal RESET is connected with the PIN4 of control chip U1.

PIN2 of ISP interface module P3 is connected with power supply VCC. PIN4, 6, 8, 10 of ISP interface module P3 are connected with each other and grounded. PIN1 of ISP interface module P3 is connected with PIN1 of control chip U1 by signal KEY5. PIN7 of ISP interface module P3 is connected with PIN3 of control chip U1 by signal KEY7. PIN9 of ISP interface module P3 is connected with PIN2 of control chip U1 by signal KEY6. PIN5 of ISP interface module P3 is connected with PIN4 of control chip U1.

Reset circuit including diode D3, capacitor C9, C10, resistor R2, R3, transistor Q1 and Switch S1, delivers the reset signal RESET to PIN4 of control chip U1.

Clock circuit includes crystal Y and capacitor C7, C8, and it is respectively connected with PIN7, 8 of control chip, and provides clock signal for control chip U1.

Communication circuit includes communication module U3, resistor R6, R7, capacitor C11-C16 and port J1, and communication circuit U3 communicates with outside equipment by port J1.

The other circuits of control module 1 are circuit of the existing technology, so we don't repeat it.

On the basis of the thermostat of the existing technology, the thermostat with GFCI in accordance with the present invention further includes independent leakage detection module 4 and has no special requirements about the type.

When leakage occurs, the current in front line L and zero curve N of the current transformer A of leakage detection module 4 would be unequal, and the induction current would be produced in current transformer A and then be delivered to leakage fault protection chip IC3 to be operated and amplified, to make the SCR terminal of the leakage fault protection chip IC3 output high level voltage after comparing with the set temperature, and to make triggers Q3 to conduct; and LED D1 conducts and illuminates by optical coupler U5, U6 and controlled silicon Q3, and indicates the circuit leakage; and the optical coupler U6 conducts and outputs a low level voltage leakage signal LOSS_E to control module 1, and control module 1 sends signal RELAY_EN to relay after receiving leakage signal and cuts it off.

Because controlled silicon Q3 can cut off it only by cutting off the anode current, control module 1 inputs high level voltage signal GFCI_STANDBY to optical coupler U5 to make the U5 stop its output. Then controlled silicon Q3 cuts off and LED D1 goes out.

The above shows and describes the basic principles, main features and the advantages of the present invention. One skilled in the art will comprehend that, the present invention should not be confined to the embodiments shown and described, and the implementation and description only describe the theory of this invention, and the foregoing and other changes in forms and details, which these fall within the scope of the appended claims, may be made without departing from the spirit and scope of the present invention. The protection range of this invention is defined by the claims and other equivalents.

1. A thermostat with GFCI for maintaining the temperature to a default value and includes control module, keyboard module and display module, which is characterized in that it further includes a leakage detection module, and the control module includes the temperature sensor, which is used to collect the external temperature, and the leakage detection module is connected with the control module, keyboard module and display module respectively, and the control module is connected with the controlled device by the leakage detection module.

2. The thermostat according to claim 1, characterized in that the leakage detection module includes a leakage fault protection chip, a detection circuit, an output circuit and a signal reset circuit.

3. The thermostat according to claim 2, characterized in that the output circuit includes two optical couplers which are used for separating input signal and output signal.

4. The thermostat according to claim 2, characterized in that the detection circuit includes a circuit which is used for deciding whether leakage exists in the circuit or not by detecting whether the current of L line and N line of the current transformer is equal.

5. The thermostat according to claim 4, characterized in that the current transformer is located near AC power source to detect whether leakage exists or not in the controlled device and the thermostat simultaneously.

6. The thermostat according to claim 2, characterized in that the leakage detection module includes the indicator which is used for indicating circuit leakage.

7. The thermostat according to claim 6, characterized in that the display module includes the display symbol which is used for indicating circuit leakage. (show points: turned into sign, symbol and feature code)

8. The thermostat according to claim 1, characterized in that the control module is connected with and controls the controlled device by relay.

9. The thermostat according to claim 1, characterized in that the control module reports the status of the thermostat by communication circuit.

10. The thermostat according to claim 3, characterized in that the detection circuit includes a circuit which is used for deciding whether leakage exists in the circuit or not by detecting whether the current of L line and N line of the current transformer is equal.

11. The thermostat according to claim 3, characterized in that the leakage detection module includes the indicator which is used for indicating circuit leakage.

12. The thermostat according to claim 5, characterized in that the leakage detection module includes the indicator which is used for indicating circuit leakage.

13. The thermostat according to claim 2, characterized in that the control module reports the status of the thermostat by communication circuit.

14. The thermostat according to claim 3, characterized in that the control module reports the status of the thermostat by communication circuit.

15. The thermostat according to claim 4, characterized in that the control module reports the status of the thermostat by communication circuit.

16. The thermostat according to claim 5, characterized in that the control module reports the status of the thermostat by communication circuit.

17. The thermostat according to claim 7, characterized in that the control module reports the status of the thermostat by communication circuit.

18. The thermostat according to claim 8, characterized in that the control module reports the status of the thermostat by communication circuit.
